(19) United States
(12) Patent Application Publication
(10) Pub. No.: US 2010/0184592 A1
(43) Pub. Date: Jul. 22, 2010

(54) PARTICLES OR COATING FOR SPLITTING WATER

(75) Inventors: Stefan Sepeur, Wadgassen (DE); Gerald Frenzer, Saarbruecken (DE); Peter W. Oliveira, Saarbruecken (DE)

Correspondence Address: COLLARD & ROE, P.C., 1077 NORTHERN BOULEVARD, ROSLYN, NY, 11576, US

(73) Assignee: NANO-X GmbH, Saarbruecken (DE)

(21) Appl. No.: 12/452,093

(22) PCT Filed: Jun. 13, 2008
(86) PCT No.: PCT/DE08/00962

§ 371 Date: Feb. 25, 2010

(30) Foreign Application Priority Data
Jun. 15, 2007 (DE) 10 2007 028 391.3

(51) Int. Cl. B01J 27/057; C23C 16/44; B05D 1/36; C25D 5/00; C25D 13/00; B05D 7/00

(52) U.S. Cl. 502/215; 427/248.1; 427/255.28; 427/402; 205/170; 204/484; 427/214

(57) ABSTRACT

The aim of the invention is to provide particles or coatings for splitting water, which are largely protected from corrosive damage. To this end, the particles or the coating consist(s) of a nucleus or a sub-layer and a shell or top layer,
the nucleus or the sub-layer forming a reactive unit and consisting of a material which, on input of energy from sunlight, releases electrons capable of splitting water into hydrogen and oxygen, and
the shell or top layer forming a protective unit capable of keeping the cleavage products away from the surface of the reactive unit and simultaneously having conductive fractions.

Surprisingly, it has been found that corrosive damage to the reactive particles is (largely) prevented by the targeted separation of the reaction particles and the cleavage products over the kinetic range of the released electrons.

The invention relates to particles or a coating for splitting water.

Solar cells of relatively low efficiency are known from the prior art. Particles that split water when they are exposed to direct solar irradiation are also known from the prior art (F. E. Osterloh, Inorganic Materials as Catalysts for Photochemical Splitting of Water, Chem. Mater. 20 (2008), 35; Ni, Meng et al., A review and recent developments in photocatalytic water-splitting using TiO₂ for hydrogen production, Renewable and Sustainable Energy Reviews (2007) 401-425; Galinska Anna, Photocatalytic Water Splitting over Pt—TiO₂ in the Presence of Sacrificial Reagents, Energy & Fuels, Vol. 19, No. 3, 2005, 1143-1147; H. von Känel et al., Photoelectrochemical Production of Hydrogen from p-Type Transition Metal Phosphides; J. Matthiesen and E. Wahlström, Charge transfer induced water splitting on the rutile TiO₂ (110) surface; A. Fujishima and K. Honda, Nature 37, 238 (1972); J. Nowotny, TiO₂ Surface Active Sites for Water Splitting, J. Phys. Chem. B 2006, 110, 18492-18495).

Examples of these include metal-doped CdS and TiO₂. Problematic here is the fact that the particles are corroded and caused to decompose by their own highly active cleavage products. As a result, the high initial yields decrease substantially within a very short time.

The object of the invention is thus to provide particles or a coating for splitting water, which are/is largely protected from corrosive damage.

This object is established within the scope of the invention for a particle according to the preamble in that the particles consist of a nucleus and a shell,
the nucleus forming a reactive unit and consisting of a material which, on input of energy from sunlight, releases electrons capable of splitting water into hydrogen and oxygen, and
the shell forming a protective unit capable of keeping the cleavage products away from the surface of the reactive unit and simultaneously having conductive fractions.

The object is likewise established within the scope of the invention for a coating according to the preamble in that the coating consists of a sub-layer and a top layer,
the sub-layer forming a reactive unit and consisting of a material which, on input of energy from sunlight, releases electrons capable of splitting water into hydrogen and oxygen, and
the top layer forming a protective unit capable of keeping the cleavage products away from the surface of the reactive unit and simultaneously having conductive fractions.

Surprisingly, it has been found that corrosive damage to the reactive unit is (largely) prevented by the targeted separation of the reactive unit and the cleavage products over the kinetic flight range of the released electrons. The particles or the coating are preferably nanoscale, but may have dimensions extending into the sub-micrometer range.

A development of the invention consists in that, in the reactive unit,
photons can be absorbed by means of elevating electrons from the electronic ground state into an excited state for a sufficient period of time,
a charge separation between the energized electrons and the positively charged mobile “holes” can be performed in an electric field,
the excitation energy of the electrons can be used to reduce, and that of the holes to oxidize, suitable molecules in an electrolyte, and
the solar radiation can be converted thermally, electrically and chemically into charge separation of the energized electrons.

It is within the scope of the invention that the reactive unit contains compounds which, when irradiated with UV light, are capable of releasing electrons and splitting water. Such compounds include, in particular, salts of subgroup metals, metalloids, salts doped with precious metals, especially TiO₂ doped with Pt, Au, Pd, Rh, Ni, Cu or Ag, TiO₂ doped with rare earth metals, especially with Fe, Mo, Ru, Os, Re, V, As, Cu, Mn or Rh, WO₃ doped with Fe, Co, Ni, Cu or Zn, TiO₂ doped with anions, especially anions of C, N, F, P or S, and compounds from the group consisting of CdS, GaAs, Ta₂O₅, doped ZrO₂, SrTiO₃, phosphides, especially ZnP₂, SiC, cerium salts, Ag/AgCl, but also of pure Si or Ge.

It is furthermore useful that the particles or the suspension contain(s) colorants, in particular thionine, toluidine blue, methylene blue, azure A, azure B, azure C, phenosafranine, safranine O, safranine T, neutral red, fluorescein, erythrosine, erythrosine B, rhodamine B, rose bengal, pyronine Y, eosine, rhodamine 6G, acridine, proflavine, acridine yellow, Fusion™ dye, crystal violet, malachite green and methyl violet.

These colorants serve the purpose of sensitization.

Am embodiment of the invention consists in that the particles or the suspension contain(s) semiconductor materials, in particular SnO₂, WO₃, V₂O₅, ZnO, Fe₂O₃, SiC or mixtures thereof.

This measure, too, serves the purpose of sensitization.

According to an embodiment of the invention, the reactive unit splits off electrons when exposed to irradiation, in particular with sunlight.

The protective unit should always be thinner than the maximum range of the electrons that have been split off.

It is also within the scope of the invention that the protective unit consists of materials that are inert towards the oxygen and hydrogen radicals formed.

According to the invention, the protective unit consists of inert oxides or salts, in particular SiO₂, Al₂O₃, ZrO₂ or BaSO₄, which are doped with inert metals, metal alloys or precious metals, or else consists of pure inert metals, metal alloys or precious metals such as Pt, Au, Pd, Rh, Ni, Cr, Cu or Ag.

It is to advantage that the protective unit has a layer thickness which is less than the maximum kinetic range of a dislocated electron, preferably smaller than the mean kinetic range of a dislocated electron.

According to an embodiment of the invention, the protective unit is at least partially permeable to the incoming radiation, in particular solar radiation.

It is also within the scope of the invention that the protective unit is permeable to electrons. It is expedient that the protective unit is impermeable to hydrogen atoms or protons. An embodiment of the invention consists in that the proportion of precious metals in the protective unit is 1 to 100 wt. %.

Lastly, the invention relates also to a method of producing a coating according to the invention, said method involving the application of a top layer serving, as a protective unit onto a dense sub-layer forming a reactive unit.

An embodiment of the invention consists in that the sub-layer and the top layer are applied using a vacuum vapour process (CVD, PVD) or electrochemically (electroplating) or by means of wet-chemical application methods, in particular a sol-gel process.

It is also possible to coat a reactive unit in the form of a particle suspension with a protective layer, using electrochemical, electroplating or wet-chemical application methods, in particular a sol-gel process.

The invention is based on the following considerations:

The first step can, in theory, ensue in any electronically energizable material, also in a single molecule as in the case of photochemical reactions.

The photoelectrolytic production of fuel, in this case direct splitting of water, depends on a number of conditions that are explained here using hydrogen generation as an example:
1. The photovoltage obtainable with the semiconductor (splitting of the quasi-Fermi level) must be greater than the voltage required for electrolysis. This is composed of the thermodynamic decomposition voltage (for water 1.23 V), the diffusion voltage required to obtain a given current density—a kinetic overvoltage characteristic of the interface of the specific semiconductor material in question—and the voltage drops across the resistors in the electric circuit (particularly in the electrolyte, in the semiconductor and at the contacts).
2. Once the photovoltage has been built up, a barrier height must remain so that the associated electric field can spatially separate the electron/hole pairs formed on exposure to light and prevent recombination. In addition, on account of unavoidable radiative recombination, the photovoltage (i.e. splitting of the quasi-Fermi level) can only reach a value lower than that corresponding to the band gap. These limitations, as a result of which the photovoltage can only reach a value about 0.5 V lower than that corresponding to the band gap, apply likewise to solid-state solar cells.

To permit a charge transfer to the electrolyte, the band edges at the interface to the electrolyte must have suitable energies. For the reduction of water, the conduction band must be far enough above (cathodic) the reduction potential of water (hydrogen potential, in neutral solution −0.42 V vs NHE) and the valence band far enough below the oxidation potential of water (oxygen potential in neutral solution +0.81 V vs NHE) for conditions 1 and 2 still to be fulfilled. If these conditions are fulfilled, the semiconductor material is theoretically suitable for direct photoelectrochemical splitting of water.

Apart from a few exceptions such as strontium titanate, however, even these do not produce hydrogen and oxygen when irradiated. This is attributable in the case of most n-type conducting materials to the fact that the holes (usually missing bonding electrons) reaching the surface of the semiconductor are more apt to oxidise and thus dissolve the semiconductor than to oxidise the water.

In any case, the condition set forth under 1 limits the maximum obtainable efficiency to about 25% (ignoring additional losses during the electrochemical reactions). However, the realistic assumption of overvoltages of around 0.3 V in the electrolyte reduces the obtainable efficiency to about 17% because the necessary band gap then permits the exploitation of only a small part of the solar spectrum.

One way of increasing the efficiency and preventing oxidation and corrosion of the particles is to generate a suitable protective layer, as is described in this paper.

The invention is explained below in more detail by reference to embodiments. By way of example, two basic formulations for the production of surface-modified nanoscale photocatalysts for splitting water are described, along with the results obtained for each:

### EXAMPLE 1

2.17 g (10.4 mmol) tetraethoxysilane TEOS in 50 ml ethanol are mixed with 0.30 g formic acid and the mixture stirred for 10 min. 0.30 g (16.7 mmol) water are added, and the mixture stirred for another hour (solution 1). Following addition of 21.5 mg (41.8 mmol) platinum(IV)bromide (from ABCR) to the partially hydrolysed silane, the solution takes on a brownish-black colour (solution 1). 3.99 g (0.05 mol) TiO₂ nanoparticles (KRONOS vpl 7000) are dispersed in 50 ml deionised water with an Ultra-Turrax for 10 min at 15,000 rpm (solution 2). Solution 1 is now added to solution 2 with vigorous stirring. A brownish-black solid forms, which is filtered and washed with water. The free OH groups at the surfaces of the TiO₂ nanoparticles are completely saturated with Pt/SiO₂ particles that form a monomolecular layer.

### EXAMPLE 2

Cadmium sulphide nanoparticles are produced by precipitation under stirring of a 0.1 molar solution of cadmium chloride in a 0.1 molar solution of sodium hydroxide and reacting the precipitated cadmium hydroxide with sodium sulphide. After having been filtered, washed with deionised water and dried at 70° C., 5.76 g (40.0 mmol) cadmium sulphide nanoparticles are dispersed in 100 g deionised water with an Ultra-Turrax for 5 min at about 11,000 rpm. 3.00 g sodium thiosulphate, 1.25 g sodium sulphite, 0.50 g thiourea and 0.40 g ammonium chloride are added to this solution. The solution is adjusted to pH 5.0 with 0.1 molar hydrochloric acid and heated to 80° C. Following addition with stirring of 0.50 g (1.26 mmol) sodium gold chloride NaAuCl₄ (from Sigma-Aldrich) and a reaction time of 10 min, the reaction mixture is cooled in an ice bath, filtered immediately and washed with water. One obtains surface-modified cadmium sulphide nanoparticles with a gold layer of approx. 5-10 nm layer thickness.

100 g of the dried catalysts is introduced into 50 ml water, irradiated with UV light (400 W, Hg) with simultaneous stirring, and the hydrogen generation measured over a period of 10 hours_{—} using GC/MS. The modified titanium dioxide nanoparticles (Example 1) show consistent hydrogen generation of 1.55 mmol/h per g catalyst over the entire measurement period, and the modified cadmium sulphide nanoparticles (Example 2) of 2.30 mmol/h per g catalyst. By comparison, the rates of hydrogen generation with unmodified nanoparticles are substantially lower (30 μmol/h per g titanium oxide catalyst and about 1.3 mmol/h per g cadmium sulphide catalyst). Photocorrosion halts hydrogen generation after about ½ hour in the case of uncoated titanium dioxide and after about 2-3 hours in the case of cadmium sulphide. In the case of unmodified calcium sulphide, sulphate detection indicates complete decomposition of the material after 4 hours of irradiation.

1. Particles for splitting water, wherein the particles consist of a nucleus and a shell,
the nucleus forming a reactive unit and consisting of a material which, on input of energy from sunlight, releases electrons capable of splitting water into hydrogen and oxygen, and
the shell forming a protective unit capable of keeping the cleavage products away from the surface of the reactive unit and simultaneously having conductive fractions
and wherein the particles are suspended in pure water, acids, bases or salts of alkali and alkaline earth metals, namely NaOH, Na₃PO₄, Na₂CO₃, NaBO₂, Na₂HPO₄, NaHCO₃, Na₂SO₄, NaCl, HCl, H₂PO₄ or H₂SO₄.

2. Coating for splitting water, wherein the coating consists of a sub-layer and a top layer,
the sub-layer forming a reactive unit and consisting of a material which, on input of energy from sunlight, releases electrons capable of splitting water into hydrogen and oxygen, and
the top layer forming a protective unit capable of keeping the cleavage products away from the surface of the reactive unit and simultaneously having conductive fractions.

3. Particles according to claim 1, wherein, in the reactive unit,
photons can be absorbed by means of elevating electrons from the electronic ground state into an excited state for a sufficient period of time
a charge separation between the energized electrons and the positively charged holes can be performed in an electric field,
the excitation energy of the electrons can be used to reduce, and that of the holes to oxidize, suitable molecules in an electrolyte, and
the solar radiation can be converted thermally, electrically and chemically into charge separation of the energized electrons.

4. Particles according to claim 1, wherein the reactive unit contains compounds which, when irradiated with UV light, are capable of releasing electrons and splitting water, said compounds including, in particular, salts of subgroup metals, metalloids, salts doped with precious metals, especially TiO₂ doped with Pt, Au, Pd, Rh, Ni, Cu or Ag, TiO₂ doped with rare earth metals, especially with Fe, Mo, Ru, Os, Re, V, As, Cu, Mn or Rh, WO₃doped with Fe, Co, Ni, Cu or Zn, TiO₂ doped with anions, especially anions of C, N, F, P or S, and compounds from the group consisting of CdS, GaAs, Ta₂O₅, doped ZrO₂, SrTiO₃, phosphides, especially ZnP₂, SiC, cerium salts, Ag/AgCl, but also of pure Si or Ge.

5. (canceled)

6. Particles according to claim 1, wherein they contain colorants, in particular thionine, toluidine blue, methylene blue, azure A, azure B, azure C, phenosafranine, safranine O, safranine T, neutral red, fluorescein, erythrosine, erythrosine B, rhodamine B, rose bengal, pyronine Y, eosine, rhodamine 6G, acridine, proflavine, acridine yellow, Fusion™ dye, crystal violet, malachite green and methyl violet.

7. Particles according to claim 1, wherein they contain semiconductor materials, in particular SnO₂, WO₃, V₂O₅, ZnO, Fe₂O₃, SiC or mixtures thereof.

8. Particles according to claim 1, wherein the reactive unit splits off electrons when exposed to irradiation, in particular with sunlight.

9. Particles according to claim 1, wherein the protective unit consists of materials that are inert towards the oxygen and hydrogen radicals formed.

10. Particles according to claim 1, wherein the protective unit consists of inert oxides or salts, in particular SiO₂, Al₂O₃, ZrO₂ or BaSO₄, which are doped with inert metals, metal alloys or precious metals, or else consists of pure inert metals, metal alloys or precious metals such as Pt, Au, Pd, Rh, Ni, Cr, Cu or Ag.

11. Particles according to claim 1, wherein the protective unit has a layer thickness which is less than the maximum kinetic range of a dislocated electron, preferably less than the mean kinetic range of a dislocated electron.

12. Particles according to claim 1, wherein the protective unit is at least partially permeable to the incoming radiation, in particular solar radiation or UV radiation.

13. Particles according to claim 1, wherein the protective unit is permeable to electrons.

14. Particles according to claim 1, wherein the protective unit is impermeable to hydrogen atoms or protons.

15. Particles or coating according to claim 10, wherein the proportion of precious metals in the protective unit is 1 to 100 wt. %.

16. Method of producing a coating according to claim 2, wherein a top layer serving as a protective unit is applied onto a dense sub-layer forming a reactive unit.

17. Method according to claim 16, wherein the sub-layer and the top layer are applied using a vacuum vapor process (CVD, PVD) or electrochemically (electroplating) or by means of wet-chemical application methods, in particular a sol-gel process.

18. Method according to claim 16, wherein a reactive unit in the form of a particle suspension is coated with a protective layer by means of electrochemical, electroplating or wet-chemical application methods, in particular a sol-gel process.
